(19) United States
(12) Patent Application Publication
(10) Pub. No.: US 2010/0324830 A1
(43) Pub. Date: Dec. 23, 2010

(54) HANDHELD OPTICAL SENSOR FOR MEASURING THE NORMALIZED DIFFERENCE VEGETATIVE INDEX IN PLANTS

(76) Inventors: JOHN B. SOLIE, Stillwater, OK (US); MARVIN L. STONE, Stillwater, OK (US); WILLIAM R. RAUN, Stillwater, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/820,669

(22) Filed: Jun. 22, 2010

Related U.S. Application Data
(60) Provisional application No. 61/219,053, filed on Jun. 22, 2009.

(51) Int. Cl. G06F 19/00; G01N 21/55

(52) U.S. Cl. 702/19; 356/445; 356/51

(57) ABSTRACT

A handheld sensor is disclosed. The sensor has a microcontroller, a current pulse control unit coupled to a light emitting diode (LED), and a photodiode. The microcontroller controls the current pulse control unit to provide a pulsed illumination of a target plant and the photodiode reads the magnitude of the reflectance from the target plant. The microcontroller accepts the reading from the photodiode and computes a normalized difference vegetative index (NDVI) based at least on the reading.

### CROSS REFERENCE TO RELATED APPLICATIONS

This application claims the priority of U.S. Provisional Patent Application No. 61/219,053 entitled “HANDHELD OPTICAL SENSOR FOR MEASURING THE NORMALIZED DIFFERENCE VEGETATIVE INDEX IN PLANTS,” filed Jun. 22, 2009, the contents of which are hereby incorporated by reference.

### STATEMENT REGARDING FEDERALLY SPONSORED RESEARCH OR DEVELOPMENT

This invention was made with government support under grant number C9-99610014-0 awarded by the U.S. Environmental Protection Agency. The government has certain rights in the invention.

### FIELD OF THE INVENTION

This disclosure relates generally to a sensor for use in precision farming and, more particularly, to a device for measuring the normalized difference vegetative index in plants.

### BACKGROUND OF THE INVENTION

The most common farming practice for applying fertilizers and other essentials to farm crops is to apply a product to an entire field at a constant rate of application. The rate of application is selected to maximize crop yield over the entire field. Unfortunately, it is the exception rather than the rule that all areas of a field have consistent soil conditions and consistent crop conditions. Accordingly, this practice typically results in over application of product over a portion of the field, which wastes money and may actually reduce crop yield, while also resulting in under application of product over other portions of the field, which may also reduce crop yield.

Perhaps an even greater problem with the conventional method is the potential to damage the environment through the over application of chemicals. Excess chemicals, indiscriminately applied to a field, ultimately find their way into the atmosphere, ponds, streams, rivers, and even aquifers. These chemicals pose a serious threat to water sources, often killing marine life, causing severe increases in algae growth, leading to eutrophication, and contaminating potable water supplies.

“Precision farming” is a term used to describe the management of intrafield variations in soil and crop conditions. “Site specific farming”, “prescription farming”, and “variable rate application technology” are sometimes used synonymously with precision farming to describe the tailoring of soil and crop management to the conditions at discrete, usually contiguous, locations throughout a field. The size of each location within a field depends on a variety of factors, such as the type of operation performed, the type of equipment used, the resolution of the equipment, as well as a host of other factors. Generally speaking, the smaller the location size, the greater the benefits of precision farming.

Precision farming techniques may include: varying the planting density of individual plants based on the ability of the soil to support growth of the plants; and the selective application of farming products such as herbicides, insecticides, and, of particular interest, fertilizer.

Thus it can be seen that there are at least three advantages to implementing precision farming practices. First, precision farming has the potential to increase crop yields, which will result in greater profits for the farmer. Second, precision farming may lower the application rates of seeds, herbicides, pesticides, and fertilizer, reducing a farmer's expense in producing a crop. Finally, precision farming will protect the environment by reducing the amount of excess chemicals applied to a field which may ultimately end up in a pond, stream, river, and/or other water source.

It will be appreciated that in order to implement precision farming, systems and methods are needed that will enable reliable determination of plant conditions within the various locations within each field.

### SUMMARY OF THE INVENTION

The present invention disclosed and claimed herein, in one aspect thereof, comprises a handheld sensor. The sensor has a microcontroller, a current pulse control unit coupled to a light emitting diode (LED), and a photodiode. The microcontroller controls the current pulse control unit to provide a pulsed illumination of a target plant and the photodiode reads the magnitude of light energy reflected from the target plant. The microcontroller accepts the reading from the photodiode and computes a normalized difference vegetative index (NDVI) based at least on the reading.

In some embodiments, the reading from the photodiode passes through a pulse passing filter and amplifier before being accepted by the microcontroller. The sensor may also include an analog to digital converter that converts the reading from the photodiode into a digital reading before the reading is accepted by the microcontroller. The LED may be an infrared LED. A near infrared LED may also be included. An incident light photodiode may detect the magnitude of light energy emitted by the LEDs. A display device can be connected to the microcontroller to display the NDVI value.

The present invention disclosed and claimed herein, in another aspect thereof, comprises a method of determining a normalized difference vegetative index (NDVI). The method includes illuminating a plant with a pulsed light source of at least two wavelengths. The magnitude of the light energy from the pulsed source on each of the at least two wavelengths is detected. A magnitude of the light energy reflected from the plant on each of the at least two wavelength is also detected. The NDVI is computed with a microcontroller based on the detected magnitudes of light energy. The method may also include filtering and amplifying the detected magnitudes of light energy to reject signals from sources other than the pulsed light source.

In some embodiments, illuminating the plant with a pulsed light source includes illuminating the plant with an infrared light emitting diode and a visible light emitting diode. Computing the NDVI with a microcontroller may further comprise determining the portion of the pulsed light source emitted that was reflected on each of the two wavelengths and dividing the difference of the two by the sum of the two.

### BRIEF DESCRIPTION OF THE DRAWINGS

FIG. 1 is a functional block diagram of a handheld optical sensor according to the present disclosure.

FIG. 2 is a perspective view of a handheld optical sensor according to the present disclosure.

FIG. 3 is an exploded perspective view of the device of FIG. 2.

FIG. 4 is a plan view of a logic board of a handheld optical sensor according to aspects of the present disclosure.

FIG. 5 is a schematic diagram of a pulse filtering circuit according to aspects of the present disclosure.

### DETAILED DESCRIPTION OF THE PREFERRED EMBODIMENTS

Reflectance of visible and near infrared light from a plant canopy can be used as a measure of the growth and performance of a plant. This phenomenon has been used to assess nitrogen uptake in plant vegetative matter and predict plant nutrient requirements (Raun et al., 2003; Raun, et al. 2007).

The device of the present disclosure utilizes a single pulse of baseband light to illuminate a target plant or plants. The magnitude of the reflected light from the pulse is measured or sampled. Using this technique, the illumination level can be greatly increased while greatly decreasing the power required to operate the sensor. At the same time, this increases the signal to noise ratio by a factor of 10 or more. Finally, the use of recently developed electronics minimizes the cost to manufacture the sensor.

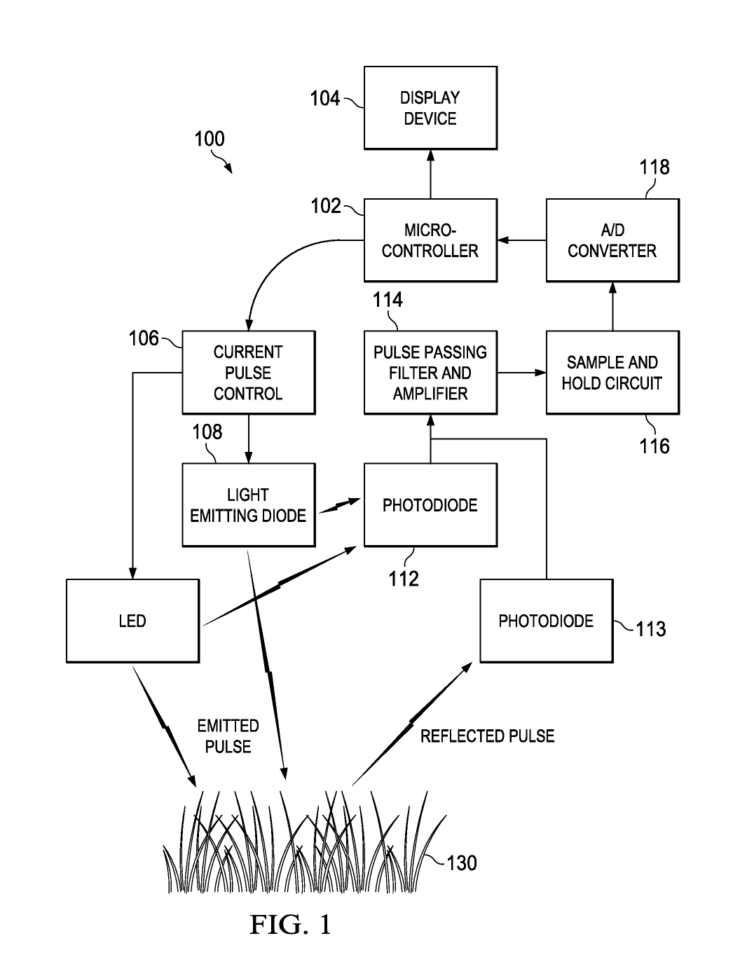

Referring now to FIG. 1, a functional block diagram of a handheld optical sensor according to the present disclosure is shown. The device 100 of FIG. 1 comprises a microcontroller 102. This may be a general purpose microcontroller or other programmable logic device, or may be an application specific integrated circuit (ASIC). In one embodiment, the microcontroller 102 is an MSP430™ available from Texas Instruments. Various other auxiliary or support chips (not shown) may also be utilized, such as USB (universal serial bus) chips or wireless communication chips allowing the microcontroller to communicate with other devices

A display device 104 may be provided and interfaced with the microcontroller 102 for providing the results of the readings, power levels, and other information. The display device 104 may be a commercially available liquid crystal display (LCD) or a simple LED segment display. In some embodiments, the display may be lighted, backlighted, or polarized for ease of use in various ambient lighting conditions.

A current pulse control unit 106 is controlled by the microcontroller and supplies voltage and current to light emitting diodes (LEDs) 108, 109. As described more fully below, there may actually be a greater number of LEDs than shown here. In one embodiment, both visible (e.g., red) and near infrared light emitting diodes will be utilized.

The current pulse control unit 106 may connect to a power supply and provide the correct voltage and current to operate the LEDs 108, 109. The pulse control unit 106 may comprise a series of amplifiers or transistors, and other components, that respond to a signal from the microcontroller 102 to illuminate or pulse the LEDs 108, 109. In one embodiment, the LEDs will be pulsed at a high magnitude (rather than modulated). This may require a relatively high amount of power, but for a relatively short amount of time. For example, the LEDs may be activated or pulsed at continuous amplitude for a period of about 50 milliseconds and then turned off. This allows the LEDs 108, 109 to cool and slows the drain on the power supply when compared to other operational modes such as modulation.

During the pulsed illumination of the LEDs 108, 109, light sensitive photo diodes 112, 113 read light from one of two sources. Diode 112 reads incident light, that is, the light coming directly from the LEDs 108, 109. The physical configuration of the components is discussed at greater length below, but the incident light read by the diode 112 substantially corresponds with the light emitted by the LEDs 108, 109 that falls upon the plant canopy 130.

The diode 113 functions as a reflected light diode. The amount of reflected light will be a portion of the incident light. The diode 113 reads the magnitude of the light reflected from the plant canopy 130. Based upon the ratio of incident light to reflected light, for visible (red) and near infrared (NIR) bands, the normalized difference vegetative index (NDVI) can be computed. The value can be utilized to determine additional amounts of nitrogen fertilizer and other chemicals that may be beneficial to the plant or plant canopy 130 in the tested location. In one embodiment, the calculation carried out by the microprocessor or microcontroller 102 to determine NDVI is:

$$NDVI = \frac{NIR - RED}{NIR + RED}$$

where NIR is the near infrared reflectance and RED is the visible reflectance.

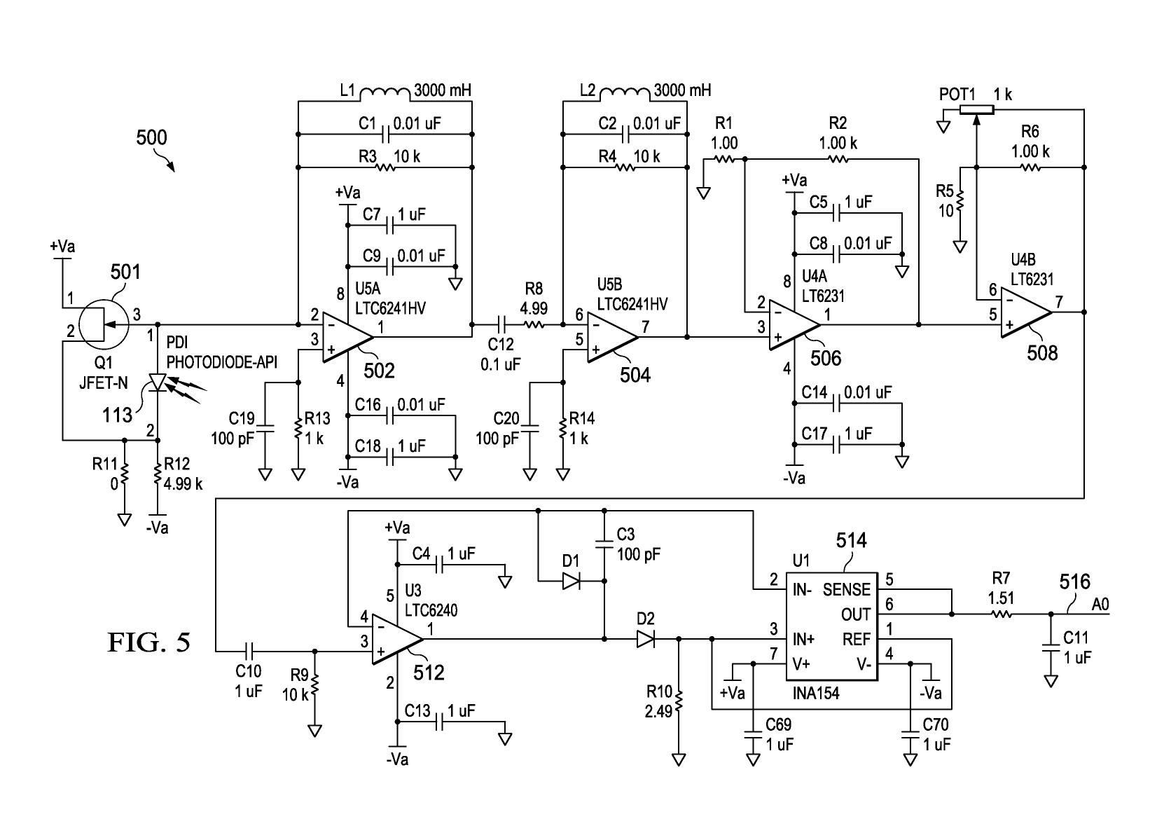

It will be appreciated that simply exposing diodes 112 and/or 113 to ambient environmental light may result in false readings and saturation. It is also important, particularly with the reflected light diode 113, to be able to distinguish light that is reflected from the plant canopy 130 due to the pulse from LEDs 108, 109 and light reflected from ambient electromagnetic sources including the sun. Therefore, a pulse passing filter and amplifier 114 provides signal conditioning to allow the true incident light and reflected light readings to be obtained. Additional details on the pulse filters are shown below with respect to FIG. 5.

After the output from the diodes 112, 113 has been properly filtered and conditioned, an analog electrical signal representing the magnitudes of the incident and reflected light, respectively, may be obtained. The microcontroller 102 may compute the NDVI and display this on the display device 104. If a digital microcontroller 102 is used, these signals may be converted to digital form by analog to digital (A/D) converter 118. A sample and hold circuit 116 may also be provided for retaining the analog signal a sufficient amount of time to allow it to be converted into a digital signal and provided to the microcontroller 102 for further processing. It is understood that many microcontrollers provide for A/D conversion on board. With such a device, some of the steps described herein could be moved onto the microprocessor and thereby reduce cost and complexity.

In some embodiments, the sensor 100 will need to be calibrated to operate properly. The calibration process is designed to account for diminishment in reflected light that may occur, even when the target is substantially completely reflective. These losses can occur due to the path the light travels through from the LEDs 108, 109 to the plant and back to the reflected light photodiode 113. Obstructions that may falsely reduce the reflected light include necessary lenses and protective covers, for example.

In one embodiment, a test card is placed in front of the sensor 100 that reflects substantially all the light from the LEDs 108, 109. In such case, the incident light should match the reflected light. However, this may not be the case and a correction factor may need to be considered. The relationship between the incident light, reflected light, and the correction factor may be represented by:

$$ρ = {C}_{1} \frac{R}{I}$$

where ρ is the reflectance, C₁ is the correction factor, R is the reflected reading, and I is the incident reading. Where the reflectance is essentially 100% in the case of the test card, the correction factor can be determined, and then utilized in later calculations to account for systemic losses of light due to lenses etc. This factor also aids in correcting for changes in the LEDs 108, 109 due to temperature, aging, and other factors.

The device of FIG. 1 may be physically packaged in a hand held format. Being hand held in size, the device may also be attached to a tractor or other vehicle and used to scan a large area. A battery or other power supply may be included. The device 100 may also accept power from an external power supply. The display device 104 may also be optional in some embodiments. In this case, the readings taken may be contained in a memory or within the microcontroller and retrieved at a later time.

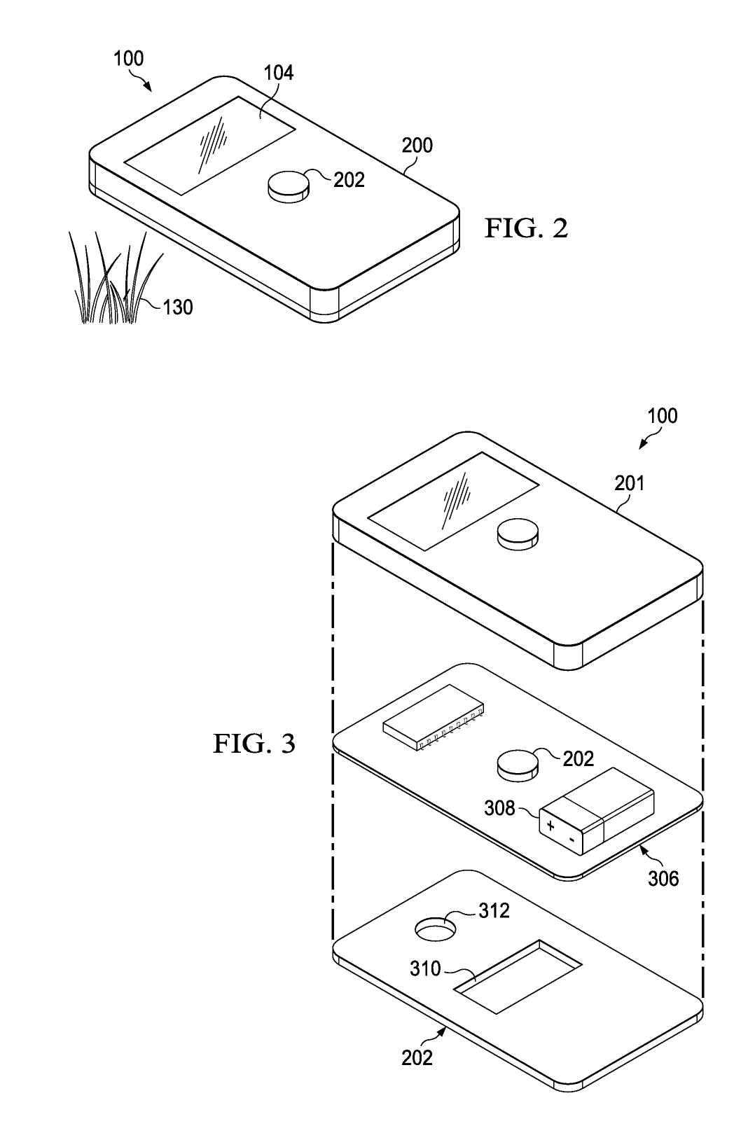

Referring now to FIG. 2, a perspective view of a handheld optical sensor 100 according to the present disclosure is shown. The handheld device 100 was described functionally with regard to FIG. 1 above. FIG. 2 provides a perspective view of one possible physical embodiment of the device 100. The device 100 as shown in FIG. 2 is simplified for ease of operation, and in the present embodiment includes only a single control input, that being button 202. In the present embodiment, the button 202 may serve to power on or wake up the device 100 while subsequent presses may activate the pulse and reading function in order to display the NDVI of the target plant canopy 130 on display device 104. It can be seen that in the present embodiment the device 100 is housed within a rugged housing 200. The housing 200 may be a polycarbonate or plastic casing, or assembled from some other durable material.

Referring now to FIG. 3, an exploded perspective view of the device 100 of FIG. 2 is shown. Here it can be seen that the handheld sensor 100 has an upper housing 200 and a lower housing 202. The two housing halves 200, 202 may snap fit together, be glued together, or be provided with fasteners. In the present embodiment, a single circuit board 306 is contained within the two housing halves 201, 202. However, in other embodiments, the various internal components of the device 100 could be assembled and fitted together on multiple circuit boards (for example, a microcontroller board and an LED board).

The upper housing 201 provides a lens 302 that protects the display device 104. A hole 304 is defined in the upper cover 201 to allow access to the button 202. It is understood that multiple buttons or interfaces may be required for other embodiments and the housing may be adapted to accommodate these.

The circuit board 306 may be a printed circuit board and may contain additional components not shown in the present view, such as wiring leads, resistive elements and other components. Here it can be seen that the single control button 202 is surface mounted directly upon the circuit board 306. Similarly, the display device 104 may mount directly to circuit board 306. In the present embodiment, the power supply or battery 308 is provided on the upper surface of the circuit board 306. The battery 308 may be a rechargeable lithium battery or some other suitable power supply.

The lower cover 202 is adapted to interfit securely with the upper cover 201. The lower cover 202 may provide various lenses or openings, such as a sensor opening 312 and an LED opening 310. In some embodiments, the housing halves 201, 202 may provide all the openings with dust or water resistant covers.

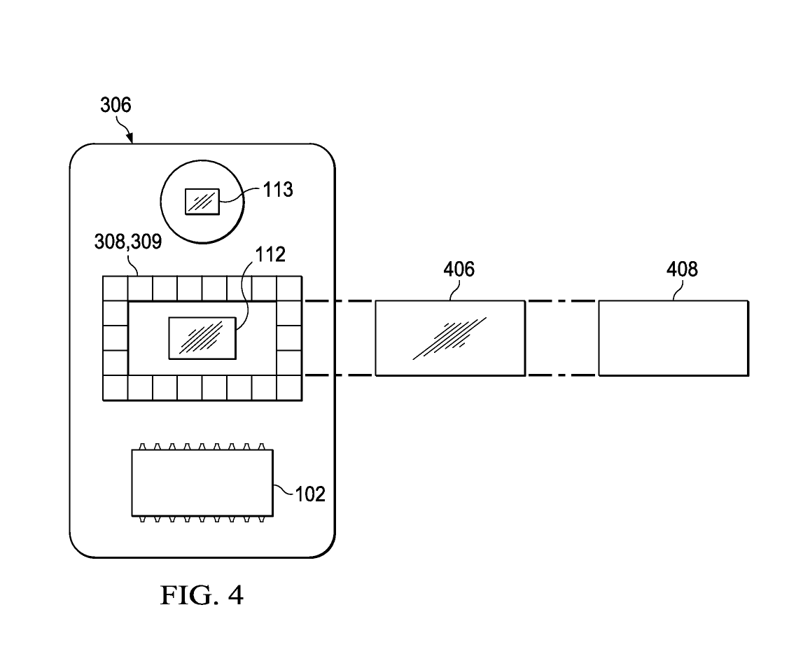

Referring now to FIG. 4, a plan view of the circuit board 306 is shown. The view of FIG. 4 is the opposite side of the circuit board 306 as seen in FIG. 3. It can be seen that the microcontroller 102 may be surface mounted to the circuit board 306. It can be seen that a plurality of light emitting diodes 108, 109 are provided in order to allow sufficient elimination of the target plant or canopy 130. The LEDs may include both infrared and near infrared LEDs as previously described. In the present embodiment, the LEDs 108, 109 are surface mounted to the circuit board 306 in a rectangular pattern. The rectangular pattern is not critical but is merely convenient in the present embodiment to allow the LEDs 108, 109 to surround the incident light photodiode 112. As described, the incident like photodiode 112 will receive light directly from the LEDs 108, 109, rather than light reflected from the plant or canopy 130. In the present embodiment, to facilitate reception of incident light only, a light pipe or lens 406 may cover the photodiode 112. This may in turn be covered by an opaque shield 408. In this way, a repeatable and predictable portion of all the light emanating from LEDs 108, 109 will be directed through the adjacent light pipe 406 into the incident light photodiode 112. Because the entire array of LEDs 108, 109 may be exposed to the plant canopy 130 through the aperture 310, the shield 408 may serve to prevent stray ambient light from striking the incident light photodiode 112.

As described previously, in operation the LEDs 108, 109 will emit a pulse of baseband light to illuminate a plant or portion of the plant canopy 130. This light will strike the plant canopy 130 and become reflected light directed back toward the handheld sensor 100. The light reflected back to the handheld sensor 100 may be collected or observed by the reflected light photodiode 113. The diode 113 may be exposed to the plant canopy 130 through the aperture 312 and the lower cover 202. In some cases, a shield 410 may be provided around the photodiode 113 to help reduce the amount of light striking the photodiode 113 that is not light that is reflected from the plant canopy 130.

Referring now to FIG. 5, a schematic diagram of a pulse filtering circuit 500 according to aspects of the present disclosure is shown. The schematic circuit 500 represents one embodiment of a circuit that is capable of properly filtering the reflected pulse to determine the amount of light being reflected by the plant canopy that may be used to compute NDVI. It will be appreciated that many other circuits could work, and circuit 500 is therefore only exemplary. In one embodiment, the circuit 500 will be adjusted to reject signals that are below about 10 KHz where the illuminating pulse is about 50 ms long. Owing to the difficulty in properly filtering pulsed signals, the operational amplifiers of the circuit 500 need to operate in a substantially linear fashion over a large magnitude of signals. FIG. 5 represents one embodiment of how such requirements can be achieved.

In the circuit 500, the reflected light photodiode 113 is connected to a field effect transistor 501. The photodiode 113 will activate when illuminated and allow a voltage drop through the field effect transistor 501. The voltage signal produced by the photodiode 113 and field effect transistor 501 is then fed into the inverting input of operational amplifier 502. An LRC feedback network is connected to the output of the operational amplifier 502 back to the inverting input. The output of the operation amplifier 502 is also provided to an RC network connecting to the inverting input of another operational amplifier 504. Once again, an LRC network is provided between the output and the inverting input of the operational amplifier 504. The same output is also provided to the non-inverting input of a third operational amplifier 506. A feedback network exists between the output and the inverting input of operational amplifier 506. In the present embodiment, it is simply a resistive network. This output is once again provided to a fourth operational amplifier 508 also having a resistive network between the output and the inverting input.

It can be seen that the resistive feedback network on operational amplifier 508 contains a potentiometer 510. It will be appreciated that a potentiometer could be used in place of any of the resistive elements of the circuit 500 in order to allow for fine tuning or adjustment of the circuit 500. Digitally adjustable potentiometers could also be used in this application. This would allow for tuning of the circuits using the microcontroller 102. Values of the other various inductive, resistive, and capacitive elements that work in the present embodiment of the disclosure are indicated. However, it is understood that one of skill in the art may arrive at a different circuit than the one shown including more or fewer operational amplifiers and feedback networks. Such alterations are within the scope of the present disclosure.

The output of operational amplifier 508 may feed into the non-inverting input of the final operational amplifier 512. The output of operational amplifier 512 may be provided to one input of a linear difference amplifier 514. A feedback network associated with the operational amplifier 512 may be provided to another terminal of the linear difference amplifier 512. An output of the amplifier 514 may be provided at 516 and provided either to an analog to digital converter for use by the microprocessor 102 or the output 516 may be provided directly into the microprocessor 102 when the microprocessor provides for internal analog digital conversion.

A pulse filtering network similar to network 500 may be provided for incident light photodiode 112 to ensure that only the pulse of light from the LEDs 108, 109 is sensed and fed to the microprocessor for further analysis and computations.

It is understood that all of the afore-described schematics are only exemplary. Other ways in which these, and other devices, may be interconnected to achieve the ends of the present disclosure are contemplated.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A handheld sensor comprising:
a microcontroller;
a current pulse control unit coupled to a light emitting diode (LED); and
a photodiode;
wherein the microcontroller controls the current pulse control unit to provide a pulsed illumination of a target plant and the photodiode reads a magnitude of light energy reflected from the target plant; and
wherein the microcontroller accepts the reading from the photodiode and computes a normalized difference vegetative index (NDVI) based at least on the reading.

2. The handheld sensor of claim 1, wherein the reading from the photodiode passes through a pulse passing filter and amplifier before being accepted by the microcontroller.

3. The handheld sensor of claim 1, further comprising an analog to digital converter that converts the reading from the photodiode into a digital reading before the reading is accepted by the microcontroller.

4. The handheld sensor of claim 1, wherein the LED comprises a visible light LED.

5. The handheld sensor of claim 1, further comprising a near infrared LED that also pulses in response to the pulse control unit.

6. The handheld sensor of claim 1, further comprising an incident light photodiode that detects the magnitude of light emitted by the LED.

7. The handheld sensor of claim 1, further comprising a display device connected to the microcontroller that displays the NDVI.

8. A method of determining a normalized difference vegetative index (NDVI), comprising:
illuminating a plant with a pulsed light source of at least two wavelengths;
detecting a magnitude of the pulsed light source on each of the at least two wavelengths;
detecting a magnitude of light reflected from the plant on each of the at least two wavelengths; and
computing the NDVI with a microcontroller based on the detected magnitudes of light.

9. The method of claim 8, further comprising filtering and amplifying the detected magnitudes of light to reject signals from sources other than the pulsed light source.

10. The method of claim 8, wherein illuminating the plant with a pulsed light source further comprises illuminating the plant with a near infrared light emitting diode and a visible light emitting diode.

11. The method of claim 8, wherein computing the NDVI with a microcontroller further comprises determining the portion of the pulsed light source emitting that was reflected on each of the two wavelengths and dividing the difference of the two by the sum of the two.

12. An optical sensor for determining a normalized difference vegetative index (NDVI) of a plant, comprising:
an near infrared light emitting diode;
a visible light emitting diode;
an incident light detecting photodiode that detects incident light from the near infrared and visible light emitting diodes and generates a first electrical signal in response;
a reflected light photodiode that detects light reflected from the near infrared and visible light emitting diodes by a plant canopy and generates a second electrical signal in response;
a first pulse passing filter that filters the first electrical signal from the incident light photodiode to reject at least a part of unwanted signals resulting from sources other than the near infrared and visible light emitting diodes;
a second pulse passing filter that filters the second electrical signal from the reflected light photodiode to reject at least a part of unwanted signals resulting from sources other than the near infrared and visible light emitting diodes; and
a microprocessor that determines the NDVI based at least on the first filtered electrical signal and the second filtered electrical signal.

13. The device of claim 12 wherein the first and second pulse passing filters also provide amplification of the electrical signals.

14. The device of claim 12, further comprising a plurality of visible light emitting diodes.

15. The device of claim 12, further comprising a plurality of near infrared light emitting diodes.

16. The device of claim 12 further comprising at least one current pulse control unit for powering the near infrared and visible light emitting diodes.

17. The device of claim 12, wherein second the pulse passing filter rejects signals lower than about 10 KHz.
